(19) United States
(12) Patent Application Publication
(10) Pub. No.: US 2008/0074695 A1
(43) Pub. Date: Mar. 27, 2008

(54) IMAGE RECORDING APPARATUS

(75) Inventors: Takahiro Ikeno, Seto-shi (JP); Masashi Suzuki, Nagoya-shi (JP); Hiroshi Koie, Nagoya-shi (JP); Kazunari Taki, Nagoya-shi (JP); Hideo Ueno, Nagoya-shi (JP); Takahiro Hosokawa, Nagoya-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/859,481

(22) Filed: Sep. 21, 2007

(30) Foreign Application Priority Data
Sep. 22, 2006 (JP) 2006-257295

(51) Int. Cl. H04N 1/00

(52) U.S. Cl. 358/1.15

(57) ABSTRACT

An image recording apparatus includes: a data reading unit that reads tag data stored in a first non-contact tag attached to the original; an image recording unit that records an image, on a recording medium, based on the image data; a data recording unit that records data read from the first non-contact tag into a second non-contact tag attached to the recording medium; a recording limitation unit that limits at least either one of recording operation by the image recording unit and recording operation by the data recording unit according to the limitation information; an operation unit that inputs an operation; and a limitation information changing unit that changes the limitation information read from the first non-contact tag according to the operation. The data recording unit records limitation information changed by the limitation information changing unit into the second non-contact tag.

### CROSS-REFERENCE TO RELATED APPLICATION

This application claims priority from Japanese Patent Application No. 2006-257295, filed on Sep. 22, 2006, the entire subject matter of which is incorporated herein by reference.

### TECHNICAL FIELD

Aspects of the present invention relate to an image recording apparatus including a data reading unit that read data from a non-contact tag attached to (embedded in) an original; image forming unit that forms an image on a recording medium; and a data writing unit that writes data into a non-contact tag attached to the recording medium.

### BACKGROUND

An image recording apparatus includes a data reading unit that reads data from a contact tag attached to an original when the non-contact tag, such as an RFID tag, is attached; an image recording unit that records an image on a recording medium in accordance with image data read from the contact tag attached to the original by the data reading unit; a data recording unit that records the data read by the data reading unit to a non-contact tag attached to the recording medium when the non-contact tag is attached; and a recording limitation unit that limits at least either recording operation performed by the image recording unit or recording operation performed by the data recording unit in accordance with limitation information when limitation information is included in the data read from the non-contact tag attached to the original by the data reading unit.

In the image recording apparatus of this type, when image data are recorded in the non-contact tag attached to an original, the data reading unit reads the image data pertaining to the original, and an image corresponding to the image data can be recorded on a recording medium by the image recording unit. Further, when the non-contact tag is attached to the recording medium, the data recording unit can also record the image data to the non-contact tag attached to the recording medium. That is, the image of the original can be copied as an image or data to the recording medium.

Further, when the image recording apparatus of this type has an image reading unit that reads an image of an original, even when image data pertaining to an original are not recorded in the non-contact tag attached to the original, the image recording unit can record the image in accordance with the image read from the original by the image reading unit.

In the meantime, the image recording apparatus of this type is considered to record, in the non-contact tag attached to the original, generation information showing the generation of an original and limitation information, such as enabled/disabled copying and the number of sheets. In this case, the generation information which is a result of addition of one generation to the generation of the original and the limitation information are written into the non-contact tag attached to the recording medium. Thus, limitations, such as enabled/disabled copying, can be managed generation after generation (see e.g. JP-A-2005-148240).

### SUMMARY

When the image formed on the original equipped with the non-contact tag is optically read and an image is formed on a recording medium in order to copy the original, error occurs in the optical reading. Therefore, when the copying is performed repeatedly by generation after generation, the errors in the optical reading are accumulated so that quality of the image deteriorates. On the other hand, when image data of the image formed on the original is recorded on the non-contact tag and an image is formed on the recording medium based on the recorded image data, no error occurs in reading the image data. Therefore, quality of the image does not deteriorate and a copy of the same quality as the image formed on the original can be obtained.

According to the method as disclosed in JP-A-2005-148240, since the limitation information is also recorded in the non-contact tag, the number of copies of the same quality as the image formed on the original can be limited.

However, when the limitation information has been first set, no changes can be made to the limitation information. For instance, when the first generation original is copied and when the second generation original is handed over to another person, it has hitherto been impossible to take measures, such as making limitations more rigid (for example, measures to disable copying of the second generation original to a third generation) according to a person to whom a copy is handed over. Aspects of the present invention relates to the above-problem. According to at least one aspect of the present invention, the image recording apparatus may be provided that can manage the generation information by recording the limitation information in a non-contact tag attached to a recording medium and can change the limitation information, if required.

An aspect of the present invention may provides an image recording apparatus includes:; a data reading unit that reads tag data stored in a first non-contact tag attached to the original, the tag data including image data and limitation information; an image recording unit that records an image, on a recording medium, based on the image data read from the first non-contact tag; a data recording unit that records data read from the first non-contact tag into a second non-contact tag attached to the recording medium; a recording limitation unit that limits at least either one of recording operation performed by the image recording unit and recording operation performed by the data recording unit according to the limitation information read from the first non-contact tag; a display unit that displays at least a part of the limitation information; an operation unit that inputs an operation; and a limitation information changing unit that changes the limitation information read from the first non-contact tag according to the input operation through the operation unit. The data recording unit records limitation information, which is changed by the limitation information changing unit, into the second non-contact tag.

### BRIEF DESCRIPTION OF THE DRAWINGS

In the accompanying drawings:

FIGS. 1A and 1B are perspective views showing the appearance of a multifunction device according to an embodiment of the present invention;

FIG. 2 is a longitudinal cross-sectional view showing the internal configuration of the multifunction device;

FIG. 3 is a descriptive view exemplifying the configuration of a sheet equipped with a non-contact tag;

FIG. 4 is a cross-sectional view diagrammatically showing the configuration of an image sensor of the multifunction device;

FIG. 5 is a block diagram showing the configuration of a control system of the multifunction device;

FIG. 6 is a flow chart showing copy processing executed by the control system;

FIG. 7 is a flowchart showing copy condition setting processing in the copy processing in detail; and

FIG. 8 is a flowchart showing missing information storing processing in the copy condition setting processing in detail.

### DETAILED DESCRIPTION

Overall Configuration of a Multifunction Device 1]

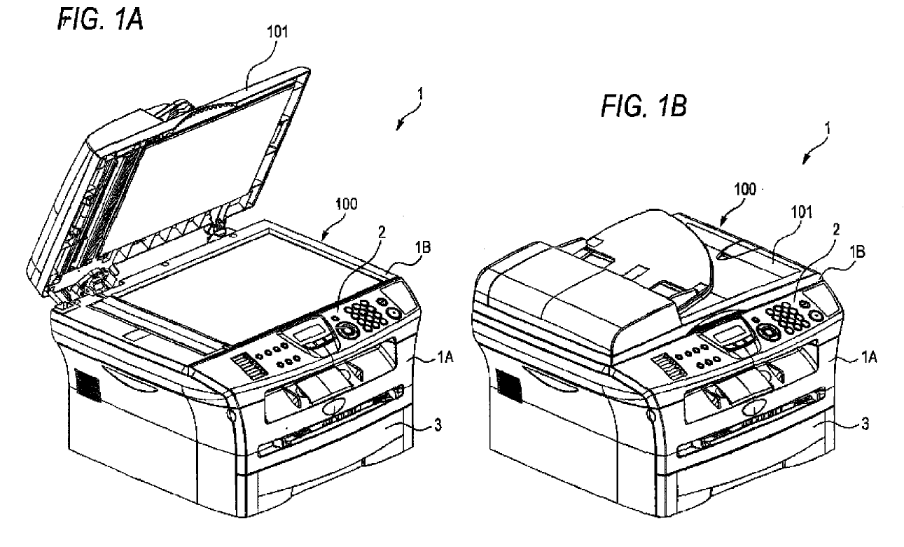

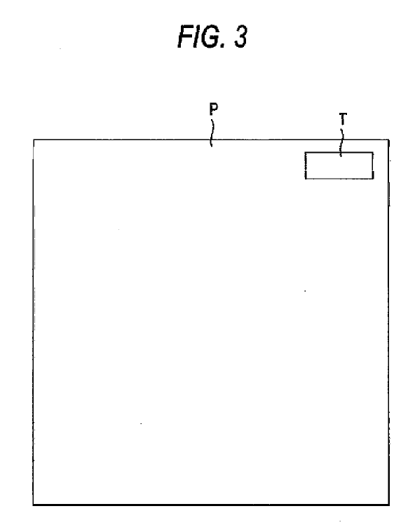

An embodiment according to the present invention will now be described with reference to the drawings. FIGS. 1A and 1B are perspective views showing the appearance of a multifunction device 1. As shown in FIGS. 1A and 1B, this multifunction device 1 includes a lower main unit 1A and an upper main unit 1B which opens and closes with respect to the lower main unit 1A. The upper main unit 1B has an image reader 100 which has a cover 101 and which serves as an image reading unit. An operation panel 2 is arranged at the front of the upper main unit 1B. The lower main unit 1A is configured, as described below, as a laser printer which records an image on a sheet P (see FIG. 3) serving as a recording medium housed in a sheet feeding cassette 3.

[Configuration of the Lower Main Unit 1A]

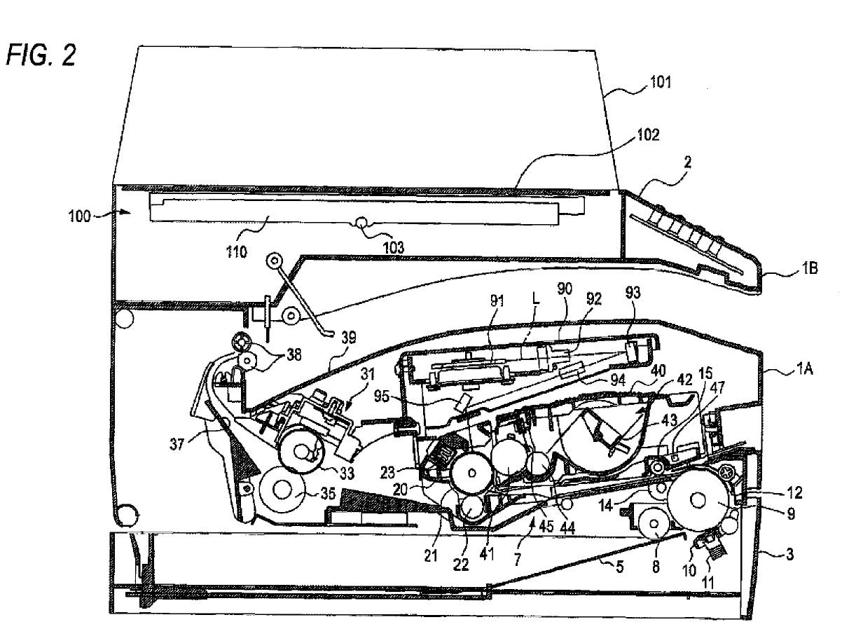

The configuration of the lower main unit 1A will now be described. As indicated by a longitudinal cross-sectional view shown in FIG. 2, a support plate 5 upwardly urged by a spring (not shown) is disposed in the sheet feeding cassette 3. A pair of feed rollers 8 and 9 is disposed above the support plate 5. The pair of feed rollers 8 and 9 separates one sheet at a time from sheets P held on the support plate 5 in a stacked manner and feeds the thus separated sheet toward an image forming section 7 to be described later. The feed roller 8 on the left side of the drawing is for conveying the uppermost sheet P toward the feed roller 9. The feed roller 9 on the right side of the drawing is a so-called pickup roller which separates and conveys the sheet P one at a time while coming into press-contact with a separation pad 10. The separation pad 10 is provided in a sheet feeding cassette 3 through a spring 11. When the sheet feeding cassette 3 is inserted into a predetermined position, the separation pad 10 is brought into press-contact with the feed roller 9 by the elastic force of the spring 11.

A guide 12 and a pair of registration rollers 14 and 15 are disposed sequentially along a path for conveying the sheet P from the feed roller 9 to the image forming section 7. The guide 12 returns the sheet P conveyed by the feed roller 9. The register rollers 14 and 15 stop the leading end of the sheet P conveyed by the feed roller 9, as required, to thus catch the sheet and make a correction to a skew of the sheet P.

The image forming section 7 serving as image cording unit includes a photosensitive drum 21 provided in a photosensitive cartridge 20 and a transfer roller 22 disposed opposite the photosensitive drum 21. The photosensitive drum 21 is a well-known drum in which a layer of organic photoreceptor (OPC) is formed around the surface of a grounded metallic core.

The sheet P on which an image is formed from toner by passing between the photosensitive drum 21 and the transfer roller 22, as will be described later, is fed to a fixing section 31. In the fixing section 31, the toner image produced on the sheet P is thermally fixed while remaining nipped between a heating roller 33 and a pressing roller 35. The sheet is then guided to an upper portion of the lower main unit 1A by a guide 37. The upwardly-guided sheet P is discharged to a sheet discharging tray 39 provided on an upper surface of the lower main unit 1A by a pair of discharge rollers 38, 38.

A scanner unit 90 which exposes the photosensitive drum 21 to a laser beam L is interposed between the sheet discharging tray 39 and the photosensitive cartridge 20. The scanner unit 90 exposes the surface of the photosensitive drum 21 with the laser beam L to produce an electrostatic latent image. As is known, this scanner unit 90 deflects the laser beam L emitted from a light source (not shown) by a polygon mirror 91, to thus expose the photosensitive drum 21 through an fθ lens 92, a reflection mirror 93, a toric lens 94, and a reflection mirror 95.

The configuration of the image forming section 7 will now be described in detail. The photosensitive cartridge 20 rotatably supports the photosensitive drum 21, and includes a transfer roller 22 and a scorotron electrification device 23 for uniformly electrifying the surface of the photosensitive drum 21. An electrostatic latent image is produced on the surface of the photosensitive drum 21 electrified by the scorotron electrification device 23, by the laser beam L emitted from the scanner unit 90. Subsequently, a developing roller 41 which is provided on a developing cartridge 40 to be described later and which serves as developing unit feeds toner to the surface of the photosensitive drum 21, thereby developing the electrostatic latent image. The thus-affixed to the photosensitive drum 21 is transferred to the sheet P passing between the transfer roller 22 and the photosensitive drum 21, and an image is produced on the sheet P through previously-described operations.

The developing roller 41 is rotatably supported by the developing cartridge 40 and comes into contact with the photosensitive drum 21, to thus be rotationally driven. The developing cartridge 40 further includes a toner storage section 42 for storing toner; an agitator 43 for agitating the toner stored in the toner storage section 42; a feeding roller 44 for feeding the toner discharged from the toner storage section 42 by the agitator 43 to the developing roller 41; a developing blade 45 for frictionally electrifying the toner adhering to the surface of the developing roller 41, to thus produce a thin layer of toner; and other elements.

A tag writer 47 serving as an example of a data recording unit is provided before the registration rollers 14 and 15 along the path for conveyance of the sheet P. As illustrated in FIG. 3, when the sheet P is equipped with a Radio Frequency Identification (RFID) Tag (hereinafter called simply “tag”) serving as an example of a non-contact tag, the tag writer 47 records data on the tag T during the course of conveyance of the sheet P.

[Configuration of the Image Reader 100]

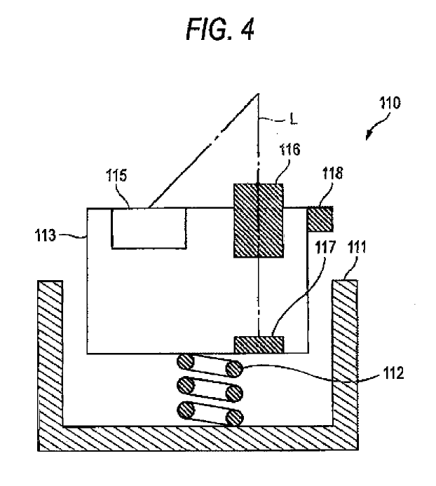

The image reader 100 has an original table 102 on which the sheet P serving as an original is to be placed and which is made of transparent glass; and an image sensor 110 supported by a rail 103 so as to be movable along the lower surface of the original table 102 in a direction perpendicular to drawing sheet of FIG. 2 (hereinafter called a “horizontal direction”). As shown in FIG. 4, the image sensor 110 has a sensor main unit 113 supported by a support section 11 through a spring 112. The support section 111 and the sensor main unit 113 are formed so as to be elongated in the horizontal direction in FIG. 2 (hereinafter called a “front-to-rear direction”).

The sensor main unit 113 has a light source 115 for illuminating light L of three colors; i.e., red, blue, and green, toward the original (not shown); and a light-receiving element 117 for receiving light L reflected from the original through a lens 116. The sensor main unit 113 includes a tag reader-and-writer 118 which is an example of data reading unit for recording data in the tag T and reading data when the sheet P shown in FIG. 3 is used as an original. The light source 115, the lens 116, the light-receiving element 117, and the tag reader-and-writer 118 are configured so as to be elongated over the essentially entire sensor main unit 113 in a longitudinal direction thereof.

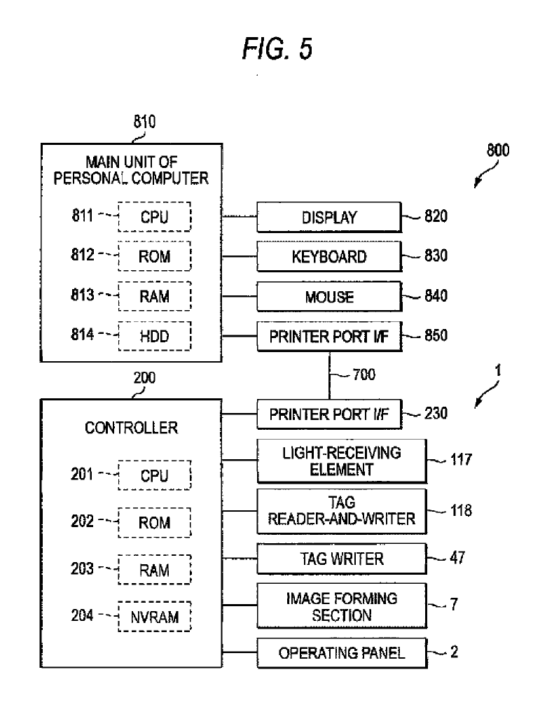

As shown in FIG. 5, the operation panel 2, the image forming section 7, the tag writer 47, the tag reader-and-writer 118, and the light-receiving element 117 are connected to a controller 200. This controller 200 is configured as a microcomputer including a CPU 201, ROM 202, and RAM 203. Further, the microcomputer 200 has NVRAM 204 in such a way that stored data are not lost even when a power switch is turned off.

This controller 200 is connected to a personal computer (herein after called a “PC”) 800 through a printer port interface (a printer port I/F) 230 and a cable 700. A PC main unit 810 of the PC 800 includes a CPU 811, ROM 812, RAM 813, and a hard disk drive (HDD) 814. This PC main unit 810 is connected to a display 820 such as a CRT, a keyboard 830, a mouse 840, a printer port interface (printer port I/F) 850 for connecting with the controller 200 of the multifunction device 1.

[Processing in the Control System]

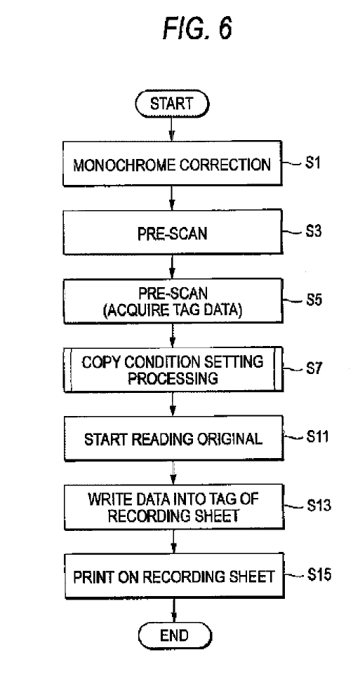

Processing performed in this control system will now be described. FIG. 6 is a flow chart showing computer processing executed by the controller 200 when copying is instructed through the operation panel 2 after the original has been placed on the original table 102. Processing is performed by the CPU 201 in accordance with a program stored in the ROM 202.

In the following descriptions, an explanation is provided mainly on the premise that a copy condition table is recorded as limitation information, such as that described below, in the tag T attached to the sheet P (hereinafter simply called an “original”) serving as an original. Specifically, as exemplified in the table below, the copy condition table recorded in the tag T includes, for each generation while an original document is taken as a first generation, settings such as the number of copy-enabled sheets, enabled/disabled copying of the data (also called tag copy) in the tag T attached to each generation of original to a tag T attached to a sheet P which is a destination of copying (also called a “recording sheet”), that is a next generation.

When portions of the copy conditions can be canceled by an input of a password, the password is also recorded in the copy condition table. An image recorded on the surface of the original equipped with the tag T recording the copy condition table is assumed to have already undergone well-known anti-counterfeit detection processing, such as appearance of a watermark “Unauthorized Copy” when the image is optically read, as is, and copied.

[Copy condition table]

| | | SETTING |
|---|---|---|
| CLASSI- | | INFOR- |
| FICATION | DESCRIPTIONS | MATION |
| FIRST | THE NUMBER OF COPY-ENABLED | 10 |
| GENERATION | SHEETS | |
| | ENABLED/DISABLED COPYING OF | ENABLED |
| | TAG DATA TO TAG | |
| SECOND | THE NUMBER OF COPY-ENABLED | 5 |
| GENERATION | SHEETS | |
| | ENABLED/DISABLED COPYING OF | ENABLED |
| | TAG DATA TO TAG | |
| THIRD | THE NUMBER OF COPY-ENABLED | 0 |
| GENERATION | SHEETS | |
| | ENABLED/DISABLED COPYING OF | DISABLED |
| | TAG DATA TO TAG | |
| OTHERS | FIRST PASSWORD | 12345 |
| | SECOND PASSWORD | 123 |

As shown in FIG. 6, when copy processing starts, light L is first emitted from the light source 115 in S1 (S designates a step, and the same also applies to any counterparts in the following descriptions) while the image sensor 110 is situated at one end of the original table 102, whereby a known black-and-white correction is made. In S3, the image sensor 110 performs a pre-scan for detecting the size of an original, presence/absence of a tag T, and presence/absence of a watermark “Unauthorized Copy” while moving along the rail 103. In S5, when the original is equipped with the tag T, the tag reader-and-writer 118 performs a pre-scan for acquiring data (hereinafter called “tag data”) recorded in the tag T. In S7, copy condition setting processing for setting conditions of the copy condition table is performed.

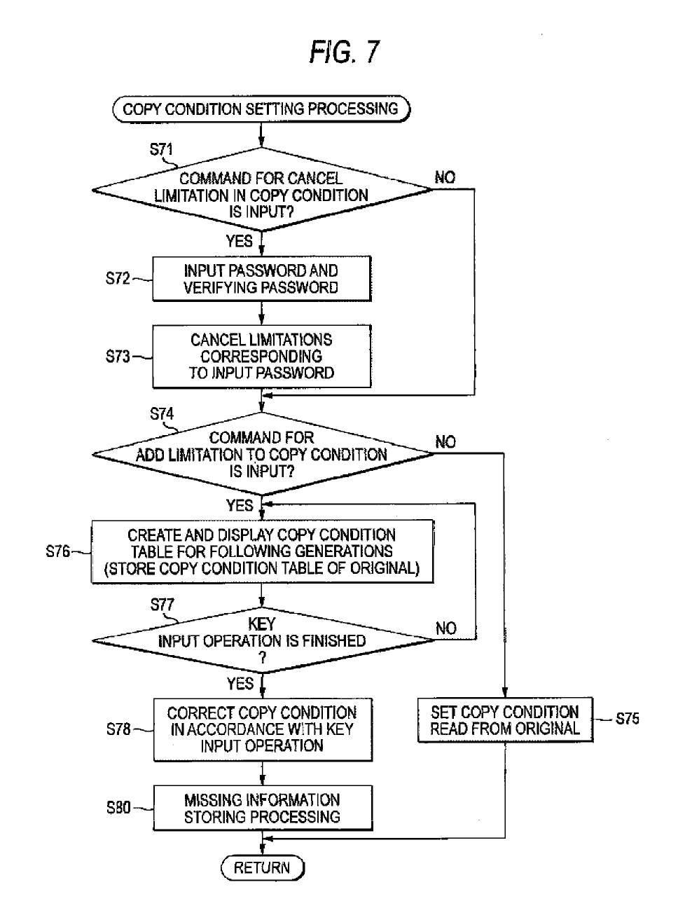

FIG. 7 is a flowchart showing details of the copy condition setting processing. In this processing, it is determined whether or not a command for canceling limitations in copy conditions is input to the operation panel 2. When the command for canceling limitations in copy conditions is input (Y in S71), a user is prompted (requested) to input a password in S72, and known processing for verifying the password is performed. In S73, copy conditions corresponding to the input password are canceled, and processing proceeds to S74. In the meantime, when the command for canceling limitations in copy conditions is not input (N in S71), processing proceeds from S71 directly to S74.

In S74, it is determined whether or not a command for adding additional limitations to the copy conditions is input to the operation panel 2. When the command for adding the additional limitations is not input (N in S74), the copy conditions set in the copy condition table in the tag T of the original except the limitations canceled in S73 are set in S75, and processing proceeds to S11. Only copy conditions are set through processing in S75, and the conditions are not recorded in the tag T attached to a recording sheet.

Turning back to FIG. 6, the image sensor 110 reads an image on the original in S11. In S13, the tag writer 47 writes data into the tag T of the recording sheet conveyed up to the registration rollers 14 and 15. The tag writer 47 writes the copy condition table corresponding to the copy conditions set in S75 into the tag T of the recording sheet. When copying of the data in the tag on the generation of the recording sheet is enabled in the copy condition table acquired from the tag T of the original, the tag writer 47 writes whole tag data in the tag T of the recording sheet in a readable manner. When copying of the tag data is not enabled, the tag writer 47 writes whole tag data while being locked by a predetermined password and written.

In S15, the image forming section 7 perform printing on the recording sheet, and processing ends. Data pertaining to the printed image are recorded in the tag T of the recording sheet. When the number of copy-enabled sheets in the copy condition table is not zero, the image is printed in accordance with the data recorded in the tag T while anti-counterfeit detection processing is being performed. Therefore, the watermark “Unauthorized Copy” is not printed in the image recorded on the recording sheet. In this case, in accordance with data pertaining to a watermark previously stored in ROM 202, a print of watermark “copy” is added to the printed image.

In the meantime, when the number of copy-enabled sheets in the copy condition table recorded in the tag T of the original is zero, the recording sheet is printed in S15 in accordance with the image optically read by the image sensor 110 in S11. In this case, as mentioned above, the watermark “Unauthorized Copy” is printed on the recording sheet. Although omitted from the drawings, at the time of completion of processing in S15, the number of copy-enabled sheets in the corresponding part of the copy condition table recorded in the tag T of the original is subtracted by one and the generation information showing that the generation information is one generation a head from the generation information recorded in the tag T of the original is written into the tag T of the recording sheet.

Turning back to FIG. 7, when additional limitations are added to the copy conditions (Y in S74), processing proceeds to S76. A copy condition table for generations following the generation of the original is created in accordance with operation of the operation panel 2 and displayed. At the time of this processing, the copy condition table acquired from the tag T of the original is stored in the RAM 203. In S77, it is determined that whether or not a key input operation performed through the operation panel 2 has been finished. When the key input operation has not been finished (N in S77), processing proceeds to S76, where preparation and display of the copy condition table are iterated. When the key input operation has been finished (Y in S77), processing proceeds to S78. In S78, the copy conditions are corrected in accordance with the key input operation. When processing proceeds to S13 after this processing, the tag writer 47 writes the copy condition table including the corrected copy condition into the tag T of the recording sheet. The tag writer 47 also writes the copy condition table acquired from the tag T of the original and stored in the RAM 203 at S76 into the tag T of the recording sheet so that the copy condition table can be restored. Accordingly, every time the copy condition is corrected generation after generation, the copy condition table recorded in the tag T is increased.

A possible correction to the copy condition through processing in from S76 to S78 is limited to a correction for adding additional limitations to the copy conditions. In the meantime, as explained above, no password is necessary to add additional limitation to the copy conditions. Accordingly, in S80 subsequent to S78, missing information storing processing, mentioned below, is performed so that the copy condition can be restored to the one which is not corrected by inputting the password set when the correction is made.

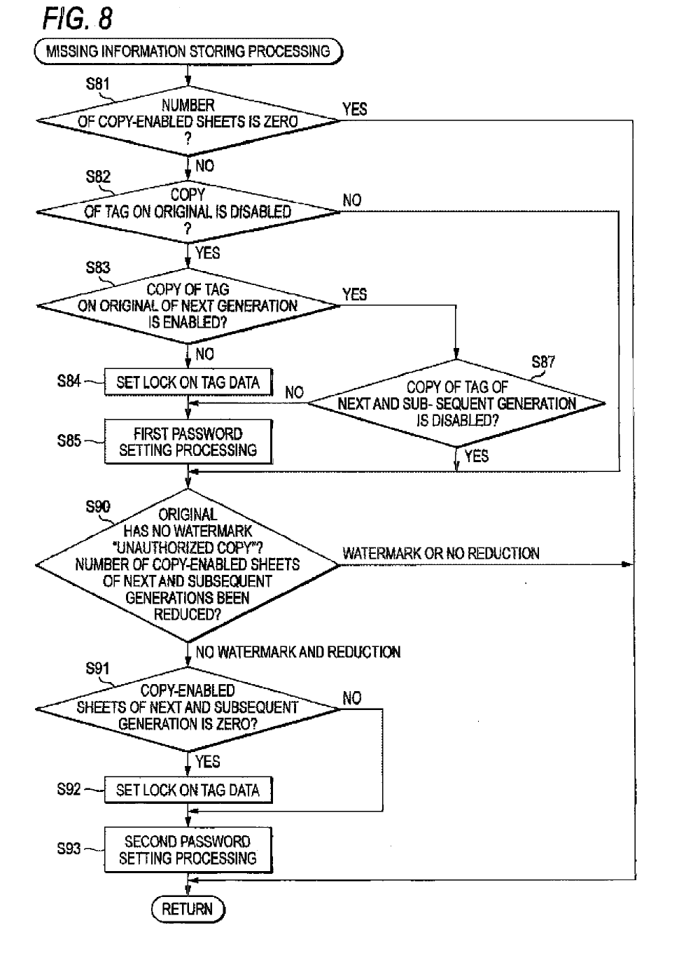

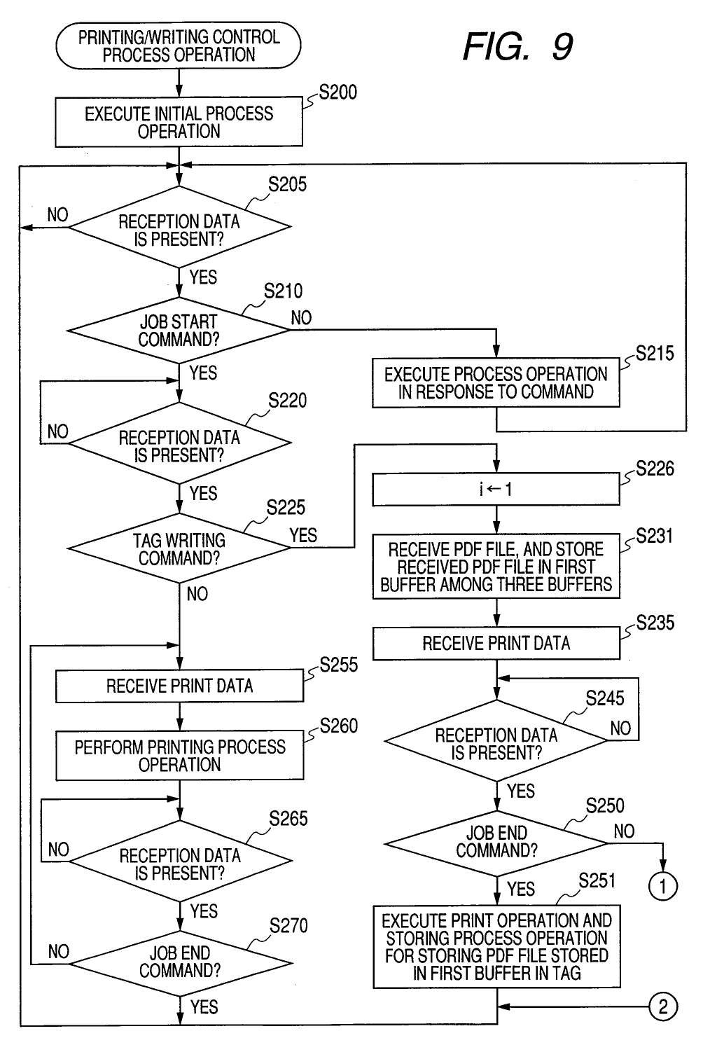

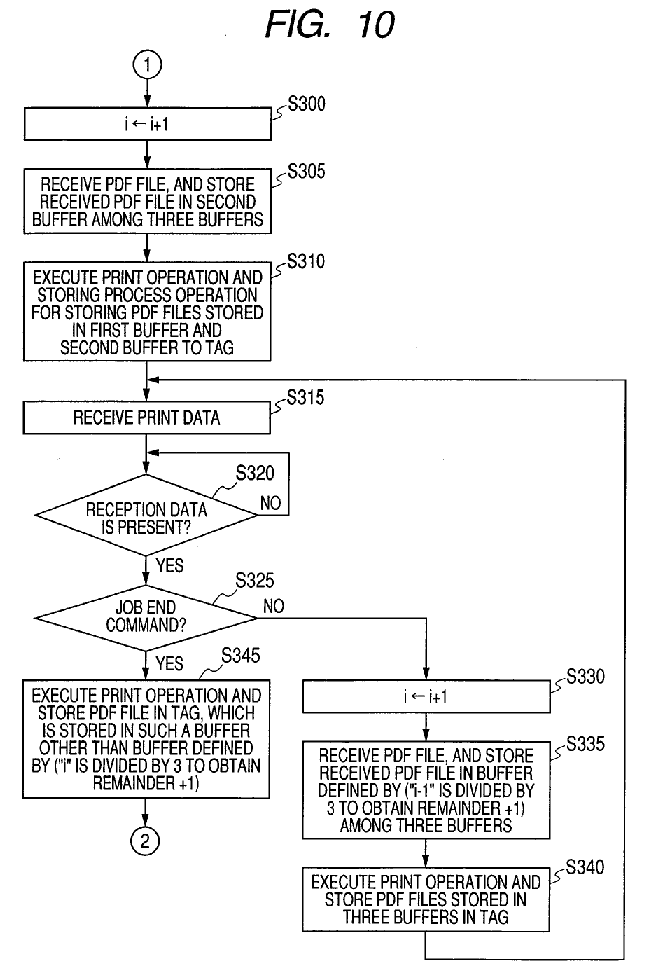

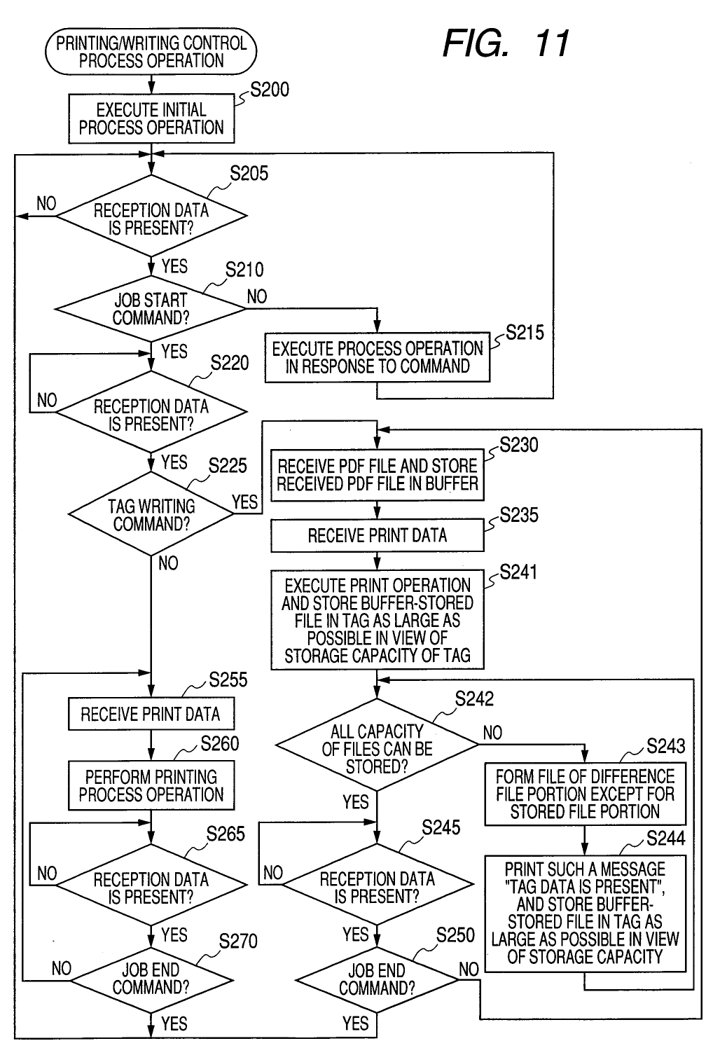

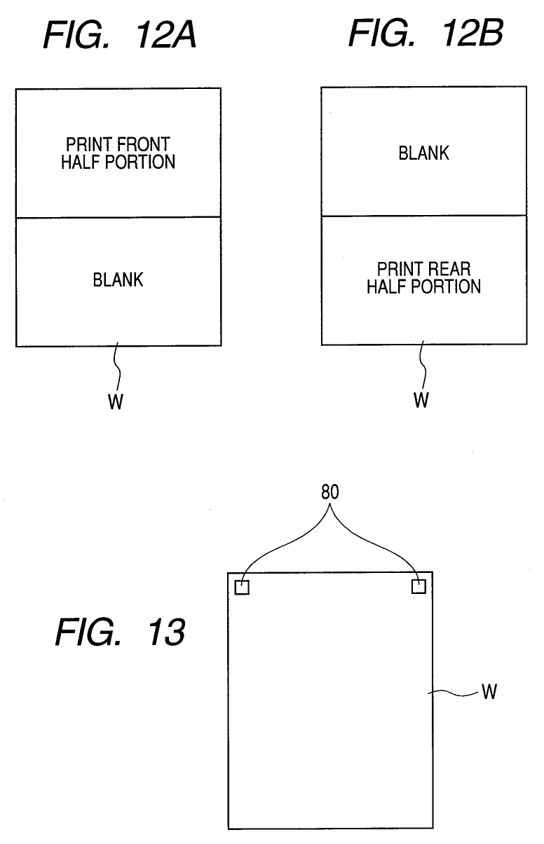

FIG. 8 is a flow chart showing the missing information storing processing in detail. As shown in FIG. 8, in S81, it is determined that whether or not the number of copy-enabled sheets in the copy condition table recorded in the tag T of the original is zero. When the number of copy-enabled sheets is zero (Y in S81), the data should not be protected by a new password, and therefore, processing proceeds to S11 directly.

When the number of copy-enabled sheets is not zero (N in S81), it is determined whether copying of the tag data (tag copy) in corresponding generation of copy condition table recorded in the tag T of the original is enabled or disabled in S82. When copying of the tag data to another tag is enabled (Y in S82), it is determined whether or not copying of the tag data to a tag of a recording sheet of the next generation is enabled. That is, it is determined whether or not copying of the tag data to a tag of another recording sheet is enabled when a copied recording sheet is taken as the original. When copying is disabled (N in S83), there is a potential risk of an inability to restore the tag data if processing in S13 is just performed. For this reason, when the copying is disabled (N in S83), after settings for locking the tag data in the tag have been made in S84, first password setting processing for setting a first password for canceling the lock is performed in S85 in accordance with operation of the operation panel 2. Even when a correction is made such that enabled copying of the tag data of the second generation to a tag of the third generation is disabled, for example, during copying of the tag data of the first generation to the tag of the second generation (N in S82 and N in S83), copying of the tag data is enabled by inputting the first password (see S72 and S73) at the time of copying of the tag of the second generation to the tag of the third generation.

When copying of the tag of the next generation is enabled (Y in S83), it is determined whether or not copying of tags of subsequent generations after the next generation is disabled in S87. When copying of tags of subsequent generations after the next is disabled (N in S87), the first password setting processing is performed in S85. In this case, copying of tags of subsequent generations after the next can be enabled by inputting the first password (see S72 and S73) at the time of copying of a tag of the next generation to a tag of a subsequent generation after the next.

After completion of first password setting processing in S85, processing proceeds to S90. When copying of the tag data is already disabled in the copy condition table recorded in the tag T of the original (N in S82), protecting the tag data by a new password is not necessary. Accordingly, processing proceeds from S82 directly to S90. When copying of a tag of the next generation is enabled (Y in S83) and when copying of tags of subsequent generations after the next is also enabled (Y in S87), this case corresponds to the case where no correction is made to the copy conditions for copying of the tag data. Therefore, in this case, processing proceeds from S87 directly to S90.

In S90, it is determined whether or not the original has the watermark “Unauthorized Copy” and the number of copy-enabled sheets of the next generation and subsequent generations has been reduced. When processing proceeds to S90, the case corresponds to a case where the number of copy-enabled sheets in the copy condition table recorded in the tag T of the original is one or more (N in S81). Therefore, the watermark “Unauthorized Copy” cannot be included in the document under normal conditions. In S90, the determination as to whether or not the original has the watermark “Unauthorized Copy” is made based on the result of pre-scan performed in S2 in preparation for the case where the copy condition table in the tag T attached to the original having the watermark “Unauthorized Copy” has been rewritten iniquitously.

When the original has the watermark “Unauthorized Copy” and when the number of copy-enabled sheets of tags of the next generation and subsequent generations is not reduced (Watermark or No Reduction in S90), there are no data to be protected by a new password. Therefore, processing proceeds to S11. In the meantime, when the original does not have the watermark “Unauthorized Copy” and when the number of copy-enabled sheets of tags of the next generation and subsequent generations has been reduced (No watermark and Reduction in S90), it is determined whether or not the numbers of copy-enabled sheets in connection with all originals of the next and subsequent generations have been set to zero in S91. When the number of copy-enabled sheets in connection with all of the documents of the next and subsequent generations have been set to zero (Y in S91), after settings for locking the tag data in the tag is made in S92, second password setting processing for setting a second password for canceling the lock is performed in S93 in accordance with operation of the operation panel 2. The, processing proceeds to S11. When the number of copy-enabled sheets in connection with all of the documents of the next and subsequent generations is not zero (N in S91), second password setting processing for returning the settings about the number of copy-enabled sheets is performed (S93), and processing proceeds to S11.

The second password set through second password setting processing (S93) is formed from a portion of the first password set through first password setting processing (S85) as shown in the copy condition table. That is, the second password consists of a part of the first password. Therefore, it may be easy for a person who sets the first password and the second password to memorize the both passwords.

### Effects of the Embodiments

As mentioned above, according to the present embodiment, copy conditions to originals of the current generation and subsequent generations can be corrected, as required. Therefore, when an original of the first generation is copied and when a resultant original of the second generation is handed over to another person, it may become possible to take measures, such as measures to make limitations more rigid (for example, copying a document of the second generation original to a third generation is disabled). Furthermore, the copy condition table which is not corrected is also recorded in the tag T of a recording sheet. Therefore, it may be easy to return the limitation to its original state by inputting of the password. In the above embodiment, processing which pertains to S13 and S15 regarding the copy condition table recorded in the tag T of the original corresponds to a recording limitation unit. Processing pertaining to S72, S73, and S76 to S80 corresponds to a limitation information changing unit. Processing pertaining to S72 corresponds to a password requesting unit. Processing pertaining to S85 and S93 corresponds to a password setting unit.

### Other Embodiment

The present invention is not limited to the embodiment that has been described above with reference to the drawings, for example, the following embodiments may also fall within the technical scope of the present invention.

For instance, the image recording unit is not limited solely to an electrophotographic image recording apparatus, such as that described in connection with the embodiment. An image recording apparatus which forms an image by ejection of ink can also be adopted. A tag which transmits or receives data by utilization of infrared radiation can also be adopted as the non-contact tag. Another conceivable embodiment is that the image recording apparatus does not have the image reader 100 but has only a tag reader and that copying of an image to a recording sheet is performed solely in accordance with the data read from the tag T of the document. Moreover, in a case where anti-counterfeit detection processing is not performed, an image may also be copied in accordance with the image read by way of the image sensor 110 in all of the cases. Moreover, missing information storing processing pertaining to S80 may also be omitted. However, in this case, it may also be the case where canceling limitations by inputting a password may become impossible.

The present invention provides illustrative, non-limiting embodiments as follows:

An image recording apparatus includes: an image reading unit that reads an image of an original; a data reading unit that reads tag data stored in a first non-contact tag attached to the original, the tag data including image data and limitation information; an image recording unit that records an image, on a recording medium, based on either one of the image read by the image reading unit and the image data read from the first non-contact tag; a data recording unit that records data read from the first non-contact tag into a second non-contact tag attached to the recording medium; a recording limitation unit that limits at least either one of recording operation performed by the image recording unit and recording operation performed by the data recording unit according to the limitation information read from the first non-contact tag; a display unit that displays at least apart of the limitation information; an operation unit that inputs an operation; and a limitation information changing unit that changes the limitation information read from the first non-contact tag according to the input operation through the operation unit. The data recording unit records limitation information, which is changed by the limitation information changing unit, into the second non-contact tag.

An image recording apparatus includes:; data reading unit that reads tag data stored in a first non-contact tag attached to the original, the tag data including image data and limitation information; an image recording unit that records an image, on a recording medium, based on the image data read from the first non-contact tag; a data recording unit that records data read from the first non-contact tag into a second non-contact tag attached to the recording medium; a recording limitation unit that limits at least either one of recording operation performed by the image recording unit and recording operation performed by the data recording unit according to the limitation information read from the first non-contact tag; a display unit that displays at least apart of the limitation information; an operation unit that inputs an operation; and a limitation information changing unit that changes the limitation information read from the first non-contact tag according to the input operation through the operation unit. The data recording unit records limitation information, which is changed by the limitation information changing unit, into the second non-contact tag.

The limitation information changing unit may include: a password setting unit that sets a password when an additional limitation is added to a limitation indicated by the limitation information; and a password requesting unit that outputs information requesting an input of the password for canceling the added additional limitation.

When a plurality of additional limitation is added to the limitation indicated by the limitation information, the password setting unit may respectively set a plurality of passwords. One of the passwords may consist of a part of another one of the passwords.

The data recording unit may record, on the second non-contact tag, both of the limitation information which is changed by the limitation information changing unit and the limitation information read from the first non-contact tag.

The data recording unit may record the image data read from the first non-contact tag into the second non-contact tag.

The limitation indicated by the limitation information may limit recording of the image data read from the first non-contact tag into the second non-contact tag by the data recording unit.

The limitation indicated by the limitation information may limit recording of the image based on the image data read from the first non-contact tag on the recording medium by the image recording unit.

According to the above configuration, the image recording unit records the image on a recording medium based on either one of an image read by the image reading unit and image data read by the data reading unit from a non-contact tag attached to the original. Moreover, when a non-contact tag is attached to the recording medium, the data recording unit records the data read by the data reading unit into the non-contact tag attached to the recording medium.

When the limitation information is included in the data read from the non-contact tag attached to the original by the data reading unit, recording limitation unit limits at least either one of recording operation performed by the image recording unit and recording operation performed by the data recording unit, in accordance with limitation information. According to the above configuration, when the data recording unit records, into the non-contact tag attached to the recording medium, the limitation information read from the non-contact tag attached to the original by the data reading unit, limitation information changing unit can change the limitation information to be recorded. Therefore, limitation information imparted to the original of the current generation and originals of subsequent generations can be changed as appropriate.

According to the above configuration, when the limitation information changing unit adds additional limitation information, the additional limitation information can be canceled by inputting a password which has been set by the password setting unit at the time of addition of the added limitation information in response to a request from the password requesting unit. In this case, a password corresponding to a limitation indicated by the limitation information among the plurality of added limitation information is configured from a portion of the password corresponding to another one of limitation indicated by the limitation information. Therefore, it may become easy for a person who has performed processing for adding the plurality of pieces of limitation information to memorize the password.

According to the above configuration, when the data recording unit records, into the non-contact tag attached to the recording medium, the limitation information read from the non-contact tag attached to the original by the data reading unit after the limitation information has been changed by the limitation information changing unit, the data recording unit may also record original limitation information and changed limitation information into the non-contact tag attached to the recording medium.

In this case, both the original limitation information and the changed limitation information are recorded into the non-contact tag attached to the recording medium. Hence, returning the limitation information to its original state is facilitated.

What is claimed is:

1. An image recording apparatus comprising:
an image reading unit that reads an image of an original;
a data reading unit that reads tag data stored in a first non-contact tag attached to the original, the tag data including image data and limitation information;
an image recording unit that records an image, on a recording medium, based on either one of the image read by the image reading unit and the image data read from the first non-contact tag;
a data recording unit that records data read from the first non-contact tag into a second non-contact tag attached to the recording medium;
a recording limitation unit that limits at least either one of recording operation performed by the image recording unit and recording operation performed by the data recording unit according to the limitation information read from the first non-contact tag;
a display unit that displays at least a part of the limitation information;
an operation unit that inputs an operation; and
a limitation information changing unit that changes the limitation information read from the first non-contact tag according to the input operation through the operation unit,
wherein the data recording unit records limitation information, which is changed by the limitation information changing unit, into the second non-contact tag.

2. The image recording apparatus according to claim 1, wherein the limitation information changing unit includes:
a password setting unit that sets a password when an additional limitation is added to a limitation indicated by the limitation information; and
a password requesting unit that outputs information requesting an input of the password for canceling the added additional limitation.

3. The image recording apparatus according to claim 2,
wherein when a plurality of additional limitation is added to the limitation indicated by the limitation information, the password setting unit respectively sets a plurality of passwords,
wherein one of the passwords consists of a part of another one of the passwords.

4. The image recording apparatus according to claim 1,
wherein the data recording unit records, on the second non-contact tag, both of the limitation information which is changed by the limitation information changing unit and the limitation information read from the first non-contact tag.

5. The image recording apparatus according to claim 1,
wherein the data recording unit records the image data read from the first non-contact tag into the second non-contact tag.

6. The image recording apparatus according to claim 5,
wherein the limitation indicated by the limitation information limits recording of the image data read from the first non-contact tag into the second non-contact tag by the data recording unit.

7. The image recording apparatus according to claim 1,
wherein the limitation indicated by the limitation information limits recording of the image based on the image data read from the first non-contact tag on the recording medium by the image recording unit.

8. An image recording apparatus comprising:
a data reading unit that reads tag data stored in a first non-contact tag attached to the original, the tag data including image data and limitation information;
an image recording unit that records an image, on a recording medium, based on the image data read from the first non-contact tag;
a data recording unit that records data read from the first non-contact tag into a second non-contact tag attached to the recording medium;
a recording limitation unit that limits at least either one of recording operation performed by the image recording unit and recording operation performed by the data recording unit according to the limitation information read from the first non-contact tag;
a display unit that displays at least a part of the limitation information;
an operation unit that inputs an operation; and
a limitation information changing unit that changes the limitation information read from the first non-contact tag according to the input operation through the operation unit,
wherein the data recording unit records limitation information, which is changed by the limitation information changing unit, into the second non-contact tag.

9. The image recording apparatus according to claim 8, wherein the limitation information changing unit includes:
a password setting unit that sets a password when an additional limitation is added to a limitation indicated by the limitation information; and
a password requesting unit that outputs information requesting an input of the password for canceling the added additional limitation.

10. The image recording apparatus according to claim 9, wherein when a plurality of additional limitation is added to the limitation indicated by the limitation information, the password setting unit respectively sets a plurality of passwords,
wherein one of the passwords consists of a part of another one of the passwords.

11. The image recording apparatus according to claim 8,
wherein the data recording unit records, on the second non-contact tag, both of the limitation information which is changed by the limitation information changing unit and the limitation information read from the first non-contact tag.

12. The image recording apparatus according to claim 8,
wherein the data recording unit records the image data read from the first non-contact tag into the second non-contact tag.

13. The image recording apparatus according to claim 12,
wherein the limitation indicated by the limitation information limits recording of the image data read from the first non-contact tag into the second non-contact tag by the data recording unit.

14. The image recording apparatus according to claim 8,
wherein the limitation indicated by the limitation information limits recording of the image based on the image data read from the first non-contact tag on the recording medium by the image recording unit.
